(19) United States
(12) Patent Application Publication
(10) Pub. No.: US 2009/0323860 A1
(43) Pub. Date: Dec. 31, 2009

(54) RECEIVING AND PROCESSING DATA

(75) Inventor: Irfan Ghauri, Cagnes sur Mer (FR)

Correspondence Address: ESCHWEILER & ASSOCIATES LLC, 629 EUCLID AVENUE, SUITE 1000, NATIONAL CITY BUILDING, CLEVELAND, OH, 44114, US

(73) Assignee: Infineon Technologies AG, Neubiberg (DE)

(21) Appl. No.: 12/147,784

(22) Filed: Jun. 27, 2008

(51) Int. Cl. H04L 27/00

(52) U.S. Cl. 375/299; 375/316

(57) ABSTRACT

A description is given of a method comprising method steps of receiving a data stream comprising first data transmitted from a first antenna and second data transmitted from a second antenna, generating a projection operator and applying the projection operator to the data stream such that the first data is separated from the data stream.

### FIELD OF THE INVENTION

This invention relates to a method and a device for receiving and processing data.

### BACKGROUND OF THE INVENTION

Radio frequency communications systems may comprise multiple transmitter antennas and multiple receiver antennas. Signals propagate from the transmitter antennas to the receiver antennas via different transmission channels. Here, interference obstructs the intended reception of the transmitted signals. Sources of interference may be: Adjacent Channel Interference (ACI), Co-Channel Interference (CCI) or inter-cell interference, multi-path interference or intra-cell interference.

### BRIEF DESCRIPTION OF THE DRAWINGS

Aspects of the invention are made more evident by way of example in the following detailed description of embodiments when read in conjunction with the attached drawing figures.

FIG. 1 schematically illustrates a communications system 100.

FIG. 2 schematically illustrates a receiver 200.

FIG. 3 schematically illustrates a further receiver 300.

FIG. 4 schematically illustrates a receiver 400 as an exemplary embodiment.

FIG. 5 schematically illustrates a method 500.

FIG. 6 schematically illustrates a receiver 600 as a further exemplary embodiment.

FIG. 7 schematically illustrates a further method 700.

FIG. 8 schematically illustrates a further method 800.

FIG. 9 schematically illustrates a receiver 900 as a further exemplary embodiment.

FIG. 10 illustrates a matrix equation 1000.

### DETAILED DESCRIPTION OF THE INVENTION

In the following, one or more aspects and embodiments of the invention are described with reference to the drawings, wherein like reference numerals are generally utilized to refer to like elements throughout. In the following description, for purposes of explanation, numerous specific details are set forth in order to provide a thorough understanding of one or more aspects of embodiments of the invention. It may be evident, however, to one skilled in the art that one or more aspects of the embodiments of the invention may be practiced with a lesser degree of these specific details. In other instances, known structures and devices are shown in block diagram form in order to facilitate describing one or more aspects of the embodiments of the invention. The following description is not to be taken in a limiting sense, and the scope of the invention is defined by the appended claims.

In addition, while a particular feature or aspect of an embodiment may be disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. The terms “coupled” and “connected”, along with derivatives may be used. It should be understood that these terms may be used to indicate that two elements co-operate or interact with each other regardless whether they are in direct physical or electrical contact, or they are not in direct contact with each other. Also, the term “exemplary” is merely meant as an example, rather than the best or optimal.

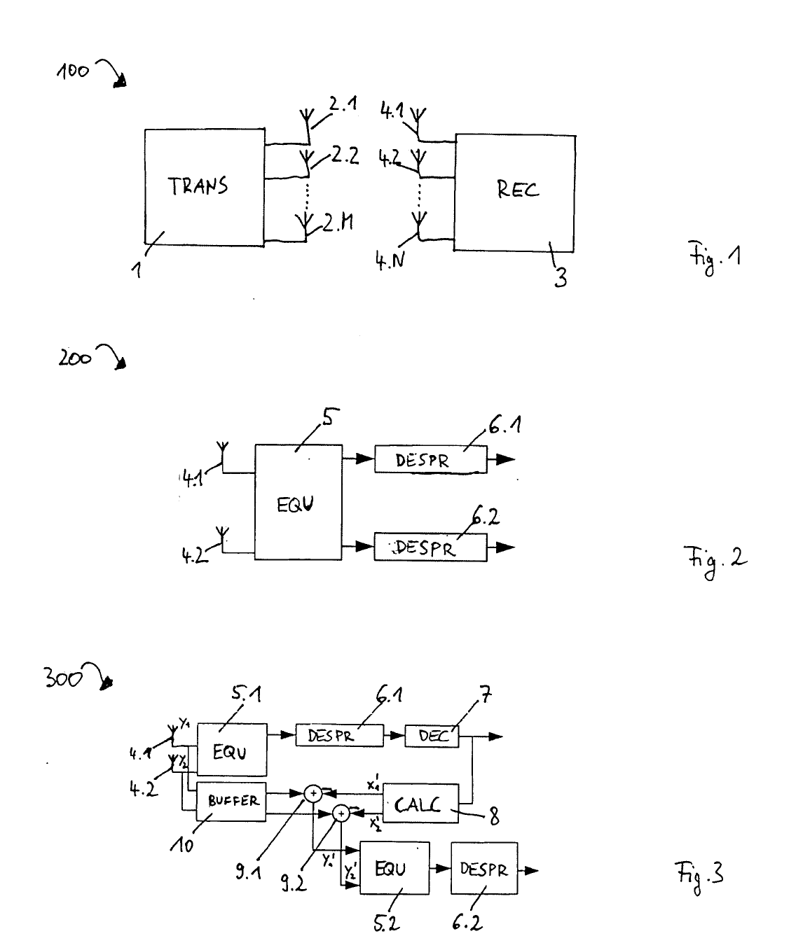

FIG. 1 schematically illustrates a communications system 100. The communications system 100 includes a transmitter 1 having M antennas 2.1 to 2.M and a receiver 3 having N antennas 4.1 to 4.N. Such a system may be referred to as Multiple-Input Multiple-Output (MIMO) system, i.e. a system employing multiple antennas at both the transmitter and the receiver in order to improve communication performance. The transmitter antennas 2.1 to 2.M and receiver antennas 4.1 to 4.N may be referred to as TX antennas and RX antennas, respectively.

A transmission of data in a MIMO system including M TX antennas and N RX antennas may be described by N times M transmission channels. The resulting overall channel may then be described by a N times M channel matrix with each of its entries representing one of the N times M transmission channels. The MIMO concept is applicable for various mobile communication standards or channel access methods, for example High-Speed Downlink Packet Access (HSDPA) or any Code Division Multiple Access (CDMA) system like CDMA2000, Interim Standard (IS) 95 or Evolution-Data Optimized (EV-DO).

During operation of the communications system 100, the transmitter 1 transmits radio frequency signals using its TX antennas 2.1 to 2.M. The radio frequency signals are transmitted over an air interface and propagate from the TX antennas 2.1 to 2.M to the RX antennas 4.1 to 4.N via various transmission channels. Here, each of the TX antennas 2.1 to 2.M sends out a data stream which may be transmitted over multiple propagation paths. FIG. 1 thus depicts one embodiment of a transmission of M data streams transmitted by the M TX antennas and, due to multipath propagation, the communications system 100 may be based on an arbitrary number of transmission channels. Interference and noise occurring between the different transmission channels may lead to a degraded link quality. It is understood that the transmitter 1 and the receiver 3 may include further components for processing signals of analog and digital form.

FIG. 2 schematically illustrates one embodiment of a receiver 200. The receiver 200 includes two RX antennas 4.1 and 4.2 connected to an equalizer 5. The equalizer 5 is connected to signal paths comprising despreaders 6.1 and 6.2. It is understood that the receiver 200 is not restricted to only include two RX antennas 4.1 and 4.2 and two despreaders 6.1 and 6.2, but may be generalized to an arbitrary number of such components. Moreover, the receiver 200 may include further components which are not explicitly illustrated for the sake of simplicity and may be arranged downstream of the despreaders 6.1 and 6.2. Usually the RX antennas 4.1 and 4.2 receive analog signals in a radio frequency range which are first down-converted into an intermediate frequency band or into the baseband by a down-conversion unit (not shown). After down-conversion, the analog signal is usually converted to a digital signal by means of an ADC (Analog-to-Digital Converter) (not shown) to provide digital samples. The digital samples may include in-phase (I) and quadrature (Q) components that are divided into digital streams of I and Q samples. Moreover, the receiver 200 may further comprise decoders, amplifiers, analog filters, digital filters, etc.

For example, the receiver 200 may receive two data streams transmitted by two TX antennas of a transmitter (not shown). The transmitted data streams may be spread in the transmitter by employing a spreading code and transmitted over an air interface via various transmission channels. The signals received by the receiver 200 are processed by the equalizer 5 which may in particular be embodied as a Linear Minimum Mean Squared Error (LMMSE) equalizer in one embodiment. The equalizer 5 performs a spatio-temporal equalization of the radio signals received at the RX antennas 4.1 and 4.2. That is, the equalizer 5 performs separation of an overall received signal into two equalized data sequences by combining and scaling the received signal spatially and temporally to restore the original signals transmitted by the TX antennas. The equalizer 5 may be referred to as a space-time equalizer.

In one embodiment, the equalizer 5 provides a possibility of suppressing interference between the two data streams transmitted by the two TX antennas. That is, each of the two data streams generated by the equalizer 5 will be devoid of contributions of the respective other TX antenna. The generated data streams are then despread by the despreaders 6.1 and 6.2 and may be processed by further components arranged downstream of the despreaders.

It is to be noted that the equalizer 5 is capable of outputting two data streams corresponding to the spreaded data streams transmitted by the TX antennas, each of the data streams being devoid of contributions of the respective other TX antenna if the number of RX antennas is greater or equals the number of TX antennas. For example, if the transmitter includes three TX antennas transmitting three data streams, a receiver including only two RX antennas and employing an equalizer 5 is not capable of separating data streams from the received signals in such a way that the separated data stream corresponds to data streams transmitted by one of the three TX antennas being devoid of contributions of the other TX antennas. This can also be seen from the fact that the channel matrix is not of full rank, i.e. the columns of the channel matrix are not linearly independent.

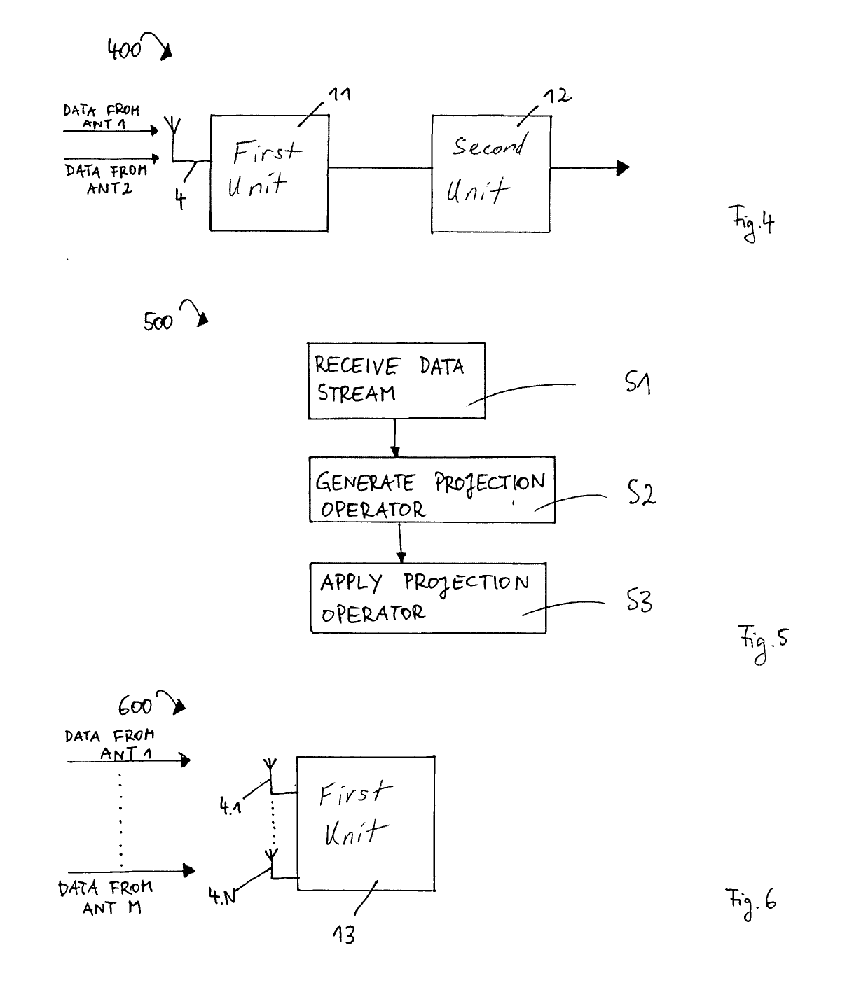

FIG. 3 schematically illustrates a receiver 300. The receiver 300 includes two RX antennas 4.1 and 4.2, each of them connected to a first and a second signal path. The first (upper) signal path includes an equalizer 5.1, a despreader 6.1 and a decoder 7 connected in series. The decoder 7 is connected to a calculation unit 8 including two outputs connected to subtracters 9.1 and 9.2. The decoder 7 may also be connected to further components of the receiver 300. The second (lower) signal path comprises a buffer 10, in one example a chip-rate buffer with two of its outputs connected to the subtracters 9.1 and 9.2. Each of the subtracters 9.1 and 9.2 is connected to an equalizer 5.2 which in turn is connected to a despreader 6.2. The despreader 6.2 may be connected to further components of the receiver 300. Similar to the receiver 200, the receiver 300 need not be restricted to merely two RX antennas, but may be generalized to an arbitrary number of RX antennas.

The RX antennas 4.1 and 4.2 receive signals y₁ and y₂, respectively, wherein each of these signals comprises a first data stream x₁ transmitted by a first TX antenna, a second data stream x₂ transmitted by a second TX antenna and noise and interference v. The overall received signals may be written as

y_{1,2}=x₁+x₂+v. (1)

It is understood that the signals y₁ and y₂ are not identical due to the spatial displacement of the RX antennas 4.1 and 4.2. The signals y₁ and y₂ are processed by the equalizer 5.1 in a similar way to the equalizer 5 of FIG. 2. As already mentioned above, data streams separated by the equalizer 5.1 correspond to the data transmitted by a specific TX antenna and devoid from contributions of the other antennas if there is no receiver noise.

In one embodiment, the separated data stream associated with the first TX antenna is despread by the despreader 6.1 and decoded by the decoder 7. The decoded data stream is then forwarded to the calculation unit 8 and further components (not shown) of the receiver 300. The calculation unit 8 generates two signals x₁′ and x₂′ replicating signals that would have been received at the RX antennas 4.1 and 4.2 if only one data stream would have been transmitted by the first TX antenna. The generation of the replica signals x₁′ and x₂′ includes all method steps performed in the transmitter, for example encoding, spreading, scrambling and channelization. The replica signals x₁′ and x₂′ are both forwarded to the subtracters 9.1 and 9.2.

The signals received at the antennas 4.1 and 4.2 are further processed in the second (lower) signal path. Here, the signals pass through a buffer 10 and are forwarded to the subtracters 9.1 and 9.2. The buffer 10 delays the received signals in such a way that they are forwarded to the subtracters 9.1 and 9.2 at the same time the calculation unit 8 forwards the replica signals x₁′ and x₂′ to the subtracters 9.1 and 9.2 as well. The size of the buffer 10 thus depends on the time required by the components 6.1, 7 and 8 to process the signal in the first signal path.

The replica signals x₁′ and x₂′ are subtracted from the signals y₁ and y₂, respectively leading to two signals y₁′ and y₂′

y_{1,2}′=y_{1,2}−x_{1,2}′. (2)

The signals y₁′ and y₂′ correspond to signals transmitted by the second TX antenna received at the first and the second RX antenna. These signals are forwarded to the equalizer 5.2 where they are processed similar to equalizer 5.1. The equalized signal is despread by the despreader 6.2 and may be forwarded to further components of the receiver 300. In contrast to the receiver 200, the receiver 300 employs in one embodiment a serial interference canceling performed by the equalizers 5.1 and 5.2. The receiver 300 may thus be referred to as a non-linear receiver or a Serial Interference Canceling (SIC) receiver.

In FIG. 3 the separation of data streams transmitted by different TX antennas relies on correctly equalizing (or separating) the data stream by equalizer 5.1. If this data stream is not equalized correctly and erroneous data is fed-back to the calculation unit 8, the subtraction performed by the subtracters 9.1 and 9.2 may add noise on the second data stream that is to be equalized by the equalizer 5.2. It is to be noted that if iterative decoders are used to decode the data stream the time delay of the buffer 10 may be significant and the receiver 300 may need to employ a buffer 10 of large size. Similar to the receiver 200, the receiver 300 is capable in one example of outputting two data streams corresponding to the spreaded data streams transmitted by the two TX antennas of the transmitter being devoid of contributions from the respective other TX antenna if the number of RX antennas is greater than or equals the number of TX antennas.

FIG. 4 schematically illustrates a receiver 400 as an exemplary embodiment. The receiver 400 comprises at least one RX antenna 4 to receive a data stream including first data transmitted by a first TX antenna and second data stream transmitted by a second TX antenna. The at least one RX antenna 4 is connected to a first unit 11 configured to generate a projection operator. The first unit 11 is connected to a second unit 12 configured to apply the projection operator to the received data stream such that the first data is separated from the data stream.

It is understood that the receiver 400 may be generalized to an arbitrary number of RX antennas that may be configured to receive data streams transmitted by an arbitrary number of TX antennas. The first unit 11 may be configured to generate further projection operators and the second unit 12 may be configured to apply these additional projection operators to the received data stream in order to generate multiple separated data streams. In one embodiment, the first unit 11 and the second unit 12 may be combined to one single unit. Of course, the receiver 400 may comprise further components as they have already been described in connection with the foregoing receivers.

It is to be noted that the receiver 400 is capable of separating data streams from the received data stream in such a way that the separated data streams correspond to data streams transmitted by one specific TX antenna being devoid of contributions from all other TX antennas. Such a separation may not have been possible for the receivers 200 and 300. The stream separation is established by applying the projection operator to the received data stream including data transmitted by all TX antennas, interference and noise. An application of the projection operator results in projecting out all data except the data transmitted by one specific TX antenna.

FIG. 5 schematically illustrates an exemplary method 500 for receiving and processing data. The method 500 comprises three steps S1 to S3 and may be read in conjunction with the receiver 400. In the first step S1, at least one RX antenna 4 of the receiver 400 receives a data stream including first data transmitted from a first TX antenna and second data transmitted from a second TX antenna. In the second step S2, the first unit 11 generates a projection operator. In the third step S3, the second unit 12 applies the projection operator to the data stream such that the first data is separated from the data stream. The separated data may then be processed by further method steps (not shown). A further detailed and exemplary description of generating and applying a projection operator will be provided in FIG. 9 and its related description.

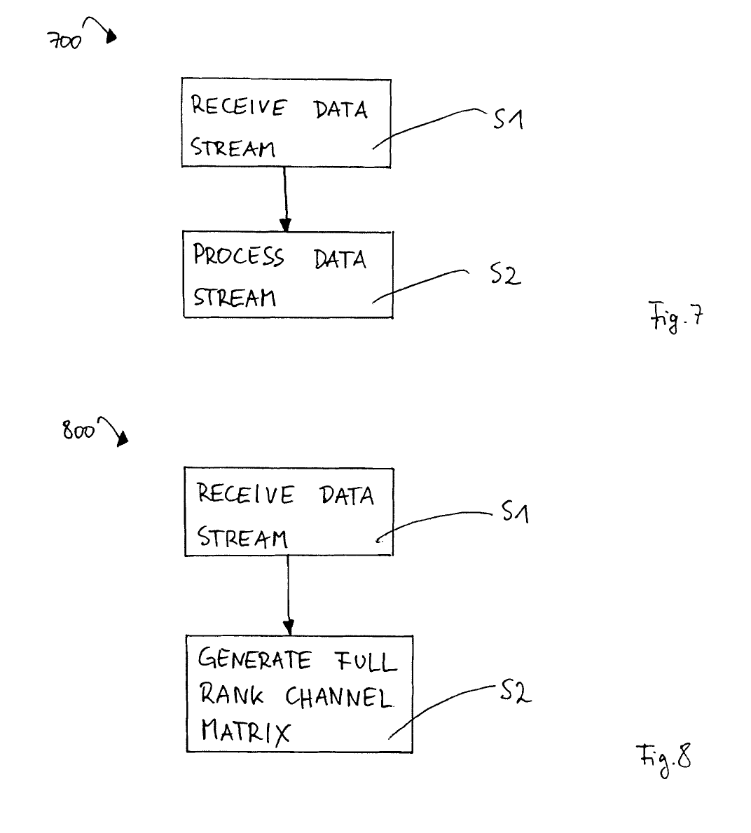

FIG. 6 schematically illustrates a receiver 600 as a further exemplary embodiment. The receiver 600 includes N RX antennas 4.1 to 4.N configured to receive a data stream including data transmitted from M TX antennas (not shown). Here in this example, the number of TX antennas is larger than the number of RX antennas, i.e. M>N. The receiver 600 further comprises a first unit 13 configured to process the received data stream such that the data transmitted by one of the TX antennas is separated from the data stream. The receiver 600 may comprise further components as described above.

The receiver 600 is capable of separating data streams from the received data stream in such a way that the separated data stream correspond to data streams transmitted by one TX antenna being devoid from contributions of the other TX antennas. In contrast to the receivers 200 and 300, the receiver 600 is capable of performing such a data separation even if the number of TX antennas is larger than the number of RX antennas. As already described above, the receivers 200 and 300 are not capable of separating data in the described way for an arrangement of M TX antennas and N RX antennas, wherein M>N.

FIG. 7 schematically illustrates an exemplary method 700 for receiving and processing data. The method 700 includes two steps S1 and S2 and may be read in conjunction with the receiver 600. In the first step S1, the N RX antennas 4.1 to 4.N receive a data stream including data transmitted from M TX antennas, wherein M>N. In the second step S2, the first unit 13 processes the data stream such that the data transmitted by one of the TX antennas is separated from the data stream. A more detailed and exemplary description of receiving and processing data in terms of the receiver 600 and the method 700 will be provided in FIG. 9 and its related description.

FIG. 8 schematically illustrates an exemplary method 800 for receiving and processing data. The method 800 includes two steps S1 and S2 and may be read in conjunction with a receiver implemented similar to the receiver 600. In the first step S1, the N RX antennas 4.1 to 4.N of the receiver 600 receive a data stream over transmission channels. The data stream includes data transmitted from M TX antennas, wherein M>N. In the second step S2, the first unit 13 generates a representation of the transmission channels in form of a full rank channel matrix. A more detailed and exemplary description of receiving and processing data in terms of the method 700 will be provided in FIG. 9 and its related description.

FIG. 9 schematically illustrates a receiver 900 as a further exemplary embodiment. The receiver 900 includes N RX antennas 4.1 to 4.N connected to a unit 14. The unit 14 is connected to signal paths including equalizers 15.1 and 15.2, despreaders 6.1 and 6.2, decoders 7.1 and 7.2 and possible further receiver components which are not explicitly illustrated for the sake of simplicity.

During operation of the receiver 900, the RX antennas 4.1 to 4.N receive data transmitted by M TX antennas (not shown). The received overall data stream includes data transmitted by the M TX antennas, noise and interference. The unit 14 processes the received data stream and outputs data streams, wherein each of these data streams is associated to one of the TX antennas. Each of the output data streams merely includes data transmitted by one specific TX antenna, i.e. all data transmitted by further TX antennas, interference and noise has been removed by the unit 14. A more detailed description of the functionality of the unit 14 will be given in the following sections. For the sake of simplicity, FIG. 9 only shows two data streams output by the unit 14.

The data streams output by the unit 14 are processed in signal paths including the components 15.1, 15.2, 6.1, 6.2, 7.1, 7.2, whose functionalities have already been described in connection with the foregoing figures. It is to be noted that the unit 14 functionally corresponds to the units 11 and 12 of the receiver 400, as well as to the unit 13 of the receiver 600.

In the following paragraphs, a first possibility of representing a signal received at an RX antenna will be explained. This representation shall be referred to as “chip-rate model”. For the case of two TX antennas, the n-th chip Yₙ of a received signal may be expressed in the chip-rate representation as

$${Y}_{n} = {H}_{1} \cdot {S}_{n , 1} \cdot {\sum }_{k = 1}^{{K}_{1}} {C}_{k , 1} \cdot {A}_{k , 1} + {H}_{2} \cdot {S}_{n , 2} \cdot {\sum }_{k = 1}^{{K}_{2}} {C}_{k , 2} \cdot {A}_{k , 2} + {V}_{n} . \qquad ( 3 )$$

Here, an incrementation of the index n leads to a new chip sample Yₙ₊₁.

The parameters H₁ and H₂ correspond to convolution matrices representing the channels seen by the first and the second TX antenna, respectively. For the case of M successive signal samples, a number of N TX antennas and a channel length of Q, the overall convolution matrix Hᵢ corresponds to an MN×(M+Q+1) matrix. Hᵢ is a Toeplitz matrix, i.e. a diagonal-constant matrix, with its first block row given by a matrix ( H̅ᵢ 0_{WN×(M-1)}). Here,

H̅ᵢ=(h_{Q}ⁱ . . . h₁ⁱ) (4)

corresponds to a channel matrix of dimension WN×Q, wherein the parameter W denotes the number of samples per chip. The matrix H̅ᵢ is formed from a channel vector

hᵢ=(h₁^{iT} . . . h_{Q}^{iT})^{T} (5)

of dimension WNQ×1. The superscript T denotes transposition. 0_{WN×(M-1)} denotes a matrix of zeros entries having a dimension of WN×(M−1).

The parameter S_{n,i} denotes a diagonal matrix corresponding to an n-th sample or n-th time instant scrambling code for the i-th TX antenna. The parameter C_{k,i} denotes a spreading code of the k-th downlink signal from the i-th TX antenna, for example an Orthogonal Variable Spreading Factor (OVSF) code. The parameter A_{k,i} denotes a symbol of the k-th signal (i.e. the k-th spreading code) from the i-th TX antenna (i.e. the i-th data stream). The parameter Vₙ denotes noise and interference contributions included in the sample Yₙ. The two sums in equation (5) run over the number of signals K₁ and K₂ transmitted by the first and the second TX antenna, respectively. It is possible that K₁=K₂ and the codes used on the two antennas may be the same.

The sample Yₙ of the received signal (cf. equation (3)) includes three contributions. The first contribution (cf. first sum and prefactors) corresponds to data transmitted by a first TX antenna, the second contribution (cf. second sum and prefactors) corresponds to data transmitted by a second TX antenna and the third contribution (cf. Vₙ) corresponds to noise and interference contributions. From equation (3) it can be seen that each of the first the second contribution corresponds to a signal that has been spread, scrambled and altered by the transmission channel.

Setting K₁=K₂=K, equation (3) can be written as a matrix equation

$${Y}_{n} = ( \begin{matrix}{H}_{1} & {H}_{2}\end{matrix} ) \cdot ( \begin{matrix}{S}_{n , 1} & 0 \\ 0 & {S}_{n , 2}\end{matrix} ) \cdot {\sum }_{k = 1}^{K} ( \begin{matrix}{C}_{k , 1} & {A}_{k , 1} \\ {C}_{k , 2} & {A}_{k , 2}\end{matrix} ) + {V}_{n} , \qquad ( 6 )$$

wherein the matrix (H₁ H₂) corresponds to an overall channel matrix Hₜₒₜₐₗ.

The equalizer 5 of FIGS. 2 and 3 is capable to estimate a symbol a_{i,d,n} corresponding to the n-th time instant symbol of the d-th signal of the i-th TX antenna. The symbol can be written as

a_{i,d,n}=c_{d}^{T}· S̅_{n,i}·T(F)·Yₙ. (7)

The parameter c_{d} denotes a spreading code of the d-th signal, for example an OVSF code or a Walsh code. Again, the superscript T denotes transposition. The parameter S̅_{n,i} denotes a descrambling matrix formed from an appropriately aligned portion of the scrambling code of the data stream transmitted by the i-th TX antenna. The parameter F denotes an equalizer vector including equalizer coefficients of the equalizer 5. The elements of the equalizer vector F may depend on the coefficients of the corresponding channel matrix in various ways, for example by way of a channel matched filter-RAKE, zero forcing or an LMMSE concept. The parameter T(F) denotes a convolution matrix formed from the equalizer coefficients.

It is to be noted that the equalizer 5 is capable of estimating the symbol a_{i,d,n} if the overall channel matrix Hₜₒₜₐₗ is a full rank matrix. However, the case of the equalizer 5 obtaining a full rank matrix Hₜₒₜₐₗ is possible if the number of RX antennas is larger than or equals the number of TX antennas. While oversampling also helps create multiple channels (in some ways like multiple antennas), it cannot in general replace the requirement of receive antennas.

In the following paragraphs, a second possibility of representing a signal received at an RX antenna will be explained. This representation shall be referred to as “symbol-rate model”. The overall channel impulse response h_{m,i} for the m-th RX antenna and the i-th TX antenna can be written as

h_{m,i}=P·ψ_{m,i}. (8)

The parameter P specifies a cascade of transmission filters, reception filters and any intermediate filters. The parameter ψ_{m,i} specifies the propagation channel associated with the m-th RX antenna and the i-th TX antenna.

The parameter h_{m,i} corresponds to a channel vector of length W·Q, wherein W denotes the number of samples per chip (i.e. the oversampling factor) and Q denotes the channel length specified in number of chips. The parameter P corresponds to a convolution matrix with its columns holding delayed versions of oversampled (oversampling factor W) pulse shapes. That is, each column of the matrix P holds a pulse shape vector prepended with zeros, wherein the number of zeros corresponds to an arrival delay of the j-th multipath component which corresponds to the j-th element of the vector ψ_{m,i}. Representing the parameter ψ_{m,i} as a vector of dimension J, the matrix P is of dimension W·Q×J. Here, the parameter J denotes the number of channel paths for the entire group of antennas.

The channel vector h_{m,i} can be written as a vector of length W·Q

h_{m,i}=(h_{m,1}^{iT} . . . h_{m,Q}^{iT})^{T}, (9)

wherein each entry corresponds to a vector channel coefficient. The channel impulse response associated with the i-th antenna can be written as a vector of dimension W·N·Q with its entries h_{m,i} being arranged in a chip-by-chip order rather than antenna element by antenna element.

The n-th sample of the received signal vector corresponds to a symbol of sent data and can be written as

Z_{i,k,n}=Hᵢ·S_{n,i}·C_{k,i}·a_{k,i,n}. (10)

The parameter S_{r.,i} denotes a diagonal matrix corresponding to an n-th time instant scrambling code for the i-th TX antenna. The parameter C_{k,i} denotes a spreading code of the k-th downlink signal from the i-th TX antenna, for example an Orthogonal Variable Spreading Factor (OVSF) code. The parameter a_{k,i,n} denotes the n-th data symbol of the k-th downlink signal from the i-th TX antenna. Hᵢ denotes an overall channel matrix corresponding to a convolution matrix with its columns holding delayed versions of a channel vector hᵢ.

The vector

g_{n,k,i}=Hᵢ·S_{n,i}C_{k,i} (11)

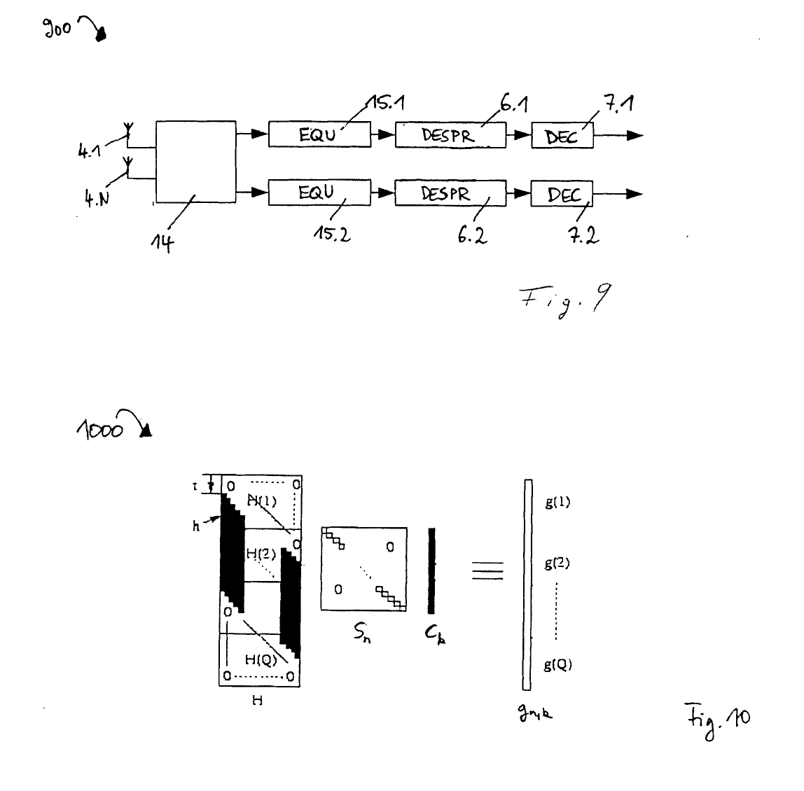

specifies the channel at symbol rate for the n-th time instant, the k-th downlink signal and the stream transmitted by the i-th TX antenna. An illustration of equation (11) in form of a matrix equation is shown in FIG. 10. Combining equations (10) and (11) leads to a symbol

Z_{i,k,n}=g_{n,k,i}·a_{k,i,n}. (12)

The overall received signal at symbol rate can now be written as

$${Y}_{n} = {\sum }_{i = 1}^{L} {\sum }_{k = 1}^{{K}_{i}} {Z}_{i , k , n} + {V}_{n} = {\sum }_{i = 1}^{L} {\sum }_{k = 1}^{{K}_{i}} {g}_{n , k , i} \cdot {a}_{k , i , n} + {V}_{n} . \qquad ( 13 )$$

The sums run over the number of TX antennas (or transmitted data streams) L and the number of signals Kᵢ transmitted by the i-th TX antenna. Again, the parameter Vₙ denotes noise and interference contributions in the received signal.

Note that equations (3) and (13) specify the received signal in terms of different representations. Equation (3) represents the received signal in the chip-rate representation, while equation (13) represents the received signal in the symbol-rate representation.

Equation (13) can be written as

$${Y}_{n} = {\sum }_{i = 1}^{L} {\sum }_{k = 1}^{{K}_{i}} {g}_{n , k , i} \cdot {a}_{k , i , n} + {V}_{n} = {\sum }_{i = 1}^{L} {G}_{i , n} \cdot {A}_{i , n} + {V}_{n} , \qquad ( 14 )$$

wherein matrices G_{i,n} and vectors A_{i,n} have been introduced. A matrix G_{i,n} corresponds to a channel matrix in the symbol-rate representation for the i-th TX antenna at the n-th time instant. A vector A_{i,n} corresponds to the n-th time instant vector of data symbols transmitted by the i-th TX antenna. Note that there is one matrix G_{i,n} and one vector A_{i,n} for each TX antenna. In equation (3) the parameter A_{k,i} has been defined as a symbol vector for the k-th spreading code from the i-th TX antenna. In contrast to this, the parameter A_{i,n} of equation (14) includes the symbols of all k spreading codes which leads to a suppression of the summation over the index k on the right hand side of equation (14).

Matrices

B_{n,i}=(G_{1,n} . . . G_{j,n} . . . G_{L,n})_{j≠i} (15)

may be generated. Each of the matrices B_{n,i} is associated with a specific TX antenna, i.e. there is one matrix B_{n,1} for each TX antenna. For example, the matrix B_{n,2} is associated with the second TX antenna and is generated by discarding the second matrix G_{2,n}. The columns of the matrices B_{n,i} may be regarded as basis vectors spanning vector spaces. For example, the columns of the matrix B_{n,2} correspond to vectors spanning a vector space associated with the second TX antenna. The set of all vectors orthogonal to one of the spaces associated with a matrix B_{n,i} corresponds to the orthogonal complement of the space and may denoted as B_{n,i}^{⊥}. For example, the space spanned by the columns of the matrix B_{n,2} is associated with its orthogonal complement B_{n,2}^{⊥}.

It is possible to generate projection operators P_{B}_{_{n,1}}^{⊥} associated with the orthogonal complements B_{n,i}^{⊥}. An application of a projection operator P_{B}_{_{n,2}}^{⊥} to a signal leads to projecting the signal on the space which is orthogonal to the space spanned by the vectors of the corresponding matrix B_{n,i} of equation (15). The projection operators may be generated by common linear algebra methods.

As already indicated, applying the projection generator P_{B}_{_{n,i}}^{⊥} associated with a specific TX antenna (cf. index i) to a received signal Yₙ results in projecting out all contributions of the other TX antennas. This leads to a data stream X̅_{n,i} devoid from data contributions transmitted by all other TX antennas, as well as noise and interference

X̅_{n,i}=P_{B}_{_{n,i}}^{⊥}·Yₙ=(I−P_{B}_{_{n,i}})·Yₙ. (16)

The symbol I denotes the unity matrix.

It is to be noted that by construction the channel matrix G_{i,r.} is full rank. That is, the symbol-rate representation provides the possibility of separating a data stream transmitted by a specific TX antenna from an overall received signal even for the case if the number of TX antennas is larger than the number of RX antennas.

Referring back to the receiver 400 of FIG. 4, it is to be noted that the generation of a projection operator by the unit 11 and the application of the projection operator by unit 12 is not restricted to a specific implementation of the units 11 and 12. The unit 11 is configured to generate a projection operator in terms of the foregoing description. There are several possibilities to implement the unit 11 such that it becomes capable of generating such a projection operator. For example, the unit 11 may include hardware components, like multipliers, summers, buffers, etc. Alternatively, the implementation of the unit 11 may be based on employing a digital signal processor. The unit 12 is configured to separate data by applying the projection generator in terms of equation (16) and may be implemented in several ways either. The same holds true for the unit 13 of FIG. 6.

FIG. 10 illustrates equation (11) in form of a matrix equation 1000 for a channel length of Q. The matrix H includes Q submatrices H(1) to H(Q). The columns of the matrix H are given by versions of the channel vector h delayed by a parameter t. The delay t corresponds to a propagation delay from the respective TX antenna to the receiver. The matrix S includes the n-th time instant scrambling code for the i-th TX antenna and is of diagonal form.

What is claimed is:

1. A method comprising:
receiving a data stream comprising a first data transmitted from a first antenna and second data transmitted from a second antenna;
generating a projection operator; and
applying the projection operator to the data stream such that the first data is separated from the data stream.

2. The method of claim 1, wherein
the data stream is transmitted over transmission channels and the method further comprises:
generating a representation of the transmission channels in form of a full rank channel matrix.

3. The method of claim 2, wherein
the channel matrix comprises a first sub-matrix depending on the transmission channels associated with the first antenna and a second sub-matrix depending on the transmission channels associated with the second antenna and the method further comprises:
generating a first matrix by discarding a sub-matrix.

4. The method of claim 3, wherein
the projection operator projects the data stream on a first subspace which is orthogonal to a second subspace spanned by columns of the first matrix.

5. The method of claim 2, wherein
an entry of the channel matrix comprises a product of a channel impulse response, a spreading code and a scrambling code.

6. The method of claim 1, further comprising:
equalizing the first data after separating the first data from the data stream, in particular by an MMSE method; and
despreading and decoding the first data after separating the first data from the data stream.

7. The method of claim 1, further comprising:
generating a further projection operator; and
applying the further projection operator to the data stream such that the second data is separated from the data stream.

8. A method comprising:
receiving a data stream at N reception antennas, the data stream comprising data transmitted from M transmission antennas, wherein M>N; and
processing the data stream such that data transmitted by one of the transmission antennas is separated from the data stream.

9. The method of claim 8, wherein
the data stream is transmitted over transmission channels and the method further comprises:
generating a representation of the transmission channels in form of a full rank channel matrix.

10. The method of claim 8, further comprising:
generating a projection operator.

11. The method of claim 8, further comprising:
equalizing the data after separating the data from the data stream, in particular by an MMSE method; and
despreading and decoding the data after separating the data from the data stream.

12. A method comprising:
receiving a data stream at N reception antennas over transmission channels, the data stream comprising a data transmitted from M transmission antennas, wherein M>N; and
generating a representation of the transmission channels in form of a full rank channel matrix.

13. The method of claim 12, further comprising:
processing the data stream such that the data transmitted by one of the transmission antennas is separated from the data stream.

14. The method of claim 12, further comprising:
equalizing the data after separating the data from the data stream, in particular by an MMSE method; and
despreading and decoding the data after separating the data from the data stream.

15. A receiver comprising:
at least one antenna to receive a data stream comprising first data transmitted from a first antenna and second data transmitted from a second antenna;
a first unit to generate a projection operator; and
a second unit to apply the projection operator to the data stream such that the first data is separated from the data stream.

16. The receiver of claim 15, wherein
the data stream is transmitted over transmission channels and the first unit is configured to generate a representation of the transmission channels in form of a full rank channel matrix.

17. The receiver of claim 16, wherein
the channel matrix comprises a first sub-matrix depending on the transmission channels associated with the first antenna and a second sub-matrix depending on the transmission channels associated with the second antenna and the first unit is configured to generate a first matrix by discarding a sub-matrix.

18. The receiver of claim 17, wherein
the projection operator projects the data stream on a first subspace which is orthogonal to a second subspace spanned by columns of the first matrix.

19. The receiver of claim 16, wherein
each entry of the channel matrix comprises a product of a channel impulse response, a spreading code and a scrambling code.

20. The receiver of claim 15, further comprising:
an equalizer for equalizing the first data after separating the first data from the data stream, wherein the equalizer is arranged downstream of the first and the second unit.

21. The receiver of claim 15, further comprising:
a despreader and a decoder for despreading and decoding the first data after separating the first data from the data stream, wherein the despreader and the decoder are arranged downstream of the first and the second unit.

22. The receiver of claim 15, wherein:
the first unit is configured to a generate a further projection operator; and
the second unit is configured to applying the further projection operator to the data stream such that the second data is separated from the data stream.

23. A receiver comprising:
N reception antennas to receive a data stream comprising data transmitted from M transmission antennas, wherein M>N; and
a first unit to process the data stream such that the data transmitted by one of the transmission antennas is separated from the data stream.

24. The receiver of claim 23, wherein
the first unit is configured to generate a representation of transmission channels in form of a full rank channel matrix and to generate a projection operator.

25. The receiver of claim 23, further comprising
an equalizer to equalize the data after separating the data from the data stream; and
a despreader and a decoder for despreading and decoding the data after separating the data from the data stream, wherein the despreader and the decoder are arranged downstream of the first and a second unit.
